(19) United States
(12) Patent Application Publication
(10) Pub. No.: US 2009/0217941 A1
(43) Pub. Date: Sep. 3, 2009

(54) SHOWER HEAD FLUSH

(76) Inventor: TRAVIS SHEPHERD, Godfrey (CA)

Correspondence Address: James Ray & Associates, 2640 Pitcairn Road, Monroeville, PA, 15146, US

(21) Appl. No.: 12/393,075

(22) Filed: Feb. 26, 2009

Related U.S. Application Data
(60) Provisional application No. 61/067,483, filed on Feb. 28, 2008.

(51) Int. Cl. B08B 3/04

(52) U.S. Cl. 134/2; 134/150

(57) ABSTRACT

An apparatus for cleaning a shower head. The apparatus comprises a substantially hollow container member having a predetermined shape and formed of a predetermined material for holding a cleaning solution. Such substantially hollow container member having a bottom portion and a sidewall portion extending upwardly from such bottom portion. The sidewall portion enclosing an entire perimeter of the bottom portion. A hanging member is disposed on a predetermined portion of the sidewall portion of such container member for hanging the substantially hollow container member from a water line having a shower head on an end thereof so that an end of such shower head is enclosed in the container member holding such cleaning solution.

### CROSS REFERENCE TO RELATED APPLICATIONS

This application is closely related to and claims benefit from U.S. Provisional Application Ser. No. 61/067,483 filed Feb. 28, 2008. This application is also closely related to co-pending U.S. patent application Ser. No. ______, filed concurrently herewith. The teaching of such co-pending application is incorporated herewith by reference thereto.

### FIELD OF THE INVENTION

The present invention relates, in general, to a shower head, and, more particularly, the present invention relates to a shower head cleaning system which provides consumers with a simple, hands free method of cleaning a shower head.

### BACKGROUND OF THE INVENTION

Currently a home homeowner, a bed and breakfast owner, a housekeeper or a gym worker must hold a container of cleanser up to the showerhead. Holding the cleaning solution above the body for an extended period of time can be difficult for someone who has one or more showers to clean. The time consuming nature of soaking a showerhead to remove dirt can be not only time consuming but also very tiring.

Thus, it would be advantageous if there were a means for cleaning a shower head which does not require all of the work that is currently needed to perform this function.

### SUMMARY OF THE INVENTION

In a first aspect the present invention provides an apparatus for cleaning a shower head. The apparatus comprises a substantially hollow container member for holding a cleaning solution and having a predetermined shape and formed of a predetermined material, such substantially hollow container member having a bottom portion and a sidewall portion extending upwardly from such bottom portion. The sidewall portion enclosing an entire perimeter of the bottom portion. A hanging means is disposed on a predetermined portion of the sidewall portion of such container member for hanging the substantially hollow container member from a water line having a shower head on an end thereof so that an end of such shower head is enclosed in the container member holding such cleaning solution.

In a second aspect the present invention provides a hands-free method of cleaning a shower head. The method comprises the steps of providing a substantially hollow container member having a substantially U-shaped member disposed on an end of the container member. There is a step of attaching the substantially hollow container member with said substantially U-shaped member to a water line having a shower head disposed on an end of the water line. Next is a step of disposing the shower head within the substantially hollow container member. Followed by a step of filling the substantially hollow container member with a cleaning solution to a depth at least sufficient to cover an end of the shower head and then soaking the shower head for a predetermined time, such predetermined time being sufficient to clean the shower head and remove any deposits built up one of thereon and therein.

### OBJECTS OF THE INVENTION

It is, therefore, one of the primary objects of the present invention to provide an apparatus for hands-free cleaning of a shower head.

Another object of the present invention is to provide an apparatus that can be connected to the water line so that the shower head is disposed within the apparatus.

Still another object of the present invention is to provide an apparatus wherein the shower head is soaked in a cleaning solution in the apparatus.

Yet another object of the present invention is to provide a hands-free method for cleaning a shower head.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of the apparatus according to an embodiment of the invention.

FIG. 2 is a side perspective view of a shower head as commonly found in showers stalls or bath tubs.

FIG. 3 is a side perspective view of the apparatus shown in FIG. 1 attached to a water line connected to a shower head with the shower head disposed within the container member ready for cleaning.

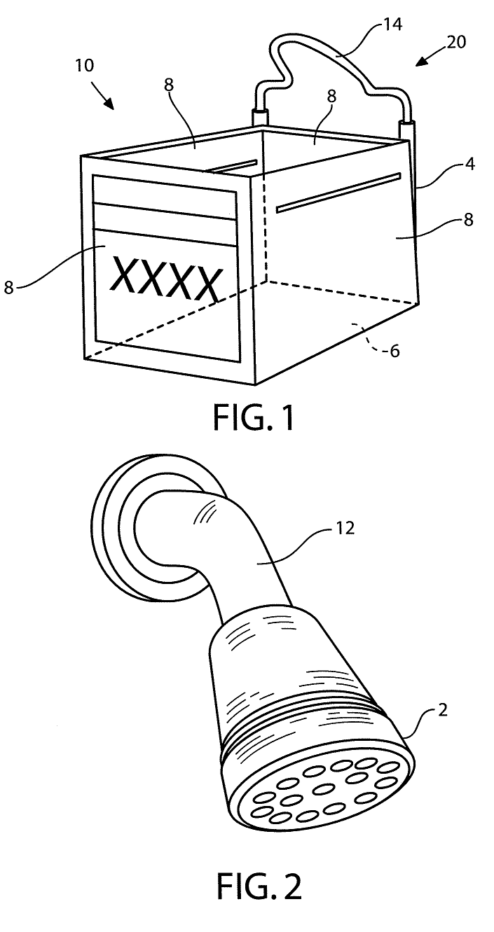

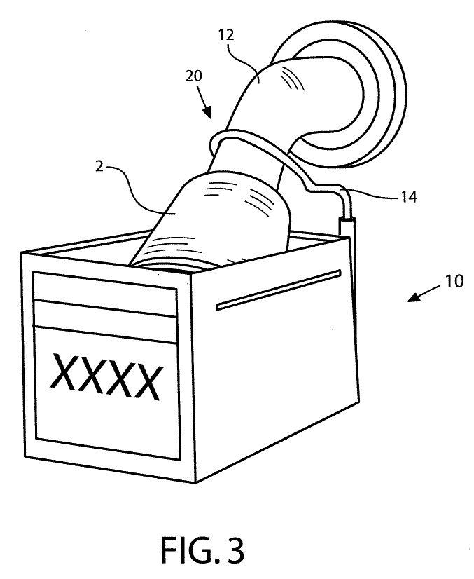

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for cleaning a shower head 2. The apparatus 10 comprises a substantially hollow container member 4 for holding a cleaning solution and having a predetermined shape and formed of a predetermined material, such substantially hollow container member 4 having a bottom portion 6 and a sidewall portion 8 extending upwardly from such bottom portion 6. The sidewall portion 8 enclosing an entire perimeter of the bottom portion 6. A hanging means, generally designated 20, is disposed on a predetermined portion of the sidewall portion 8 of such container member 4 for hanging the substantially hollow container member 4 from a water line 12 having a shower head 2 on an end thereof so that an end of such shower head 2 is enclosed in the container member 8 holding such cleaning solution.

Such hanging means 20 includes a generally U-shaped member 14 for attachment with a water line 12 having a shower head 2 disposed on an end of such water line 12 wherein such end of such shower head 2 is disposed within the substantially hollow container member 4.

The predetermined shape of the substantially hollow container member 4 is one of oval, circular and rectangular. It is presently preferred that the predetermined shape is substantially rectangular. Such rectangular substantially hollow container member 4 is between about 2½ inches and about 3½ inches wide and between about 4½ inches and about 5½ inches long and between about 2½ inches and about 3½ inches high.

Such predetermined material is selected from one of plastic and metal. It is presently preferred that such material is plastic.

In a second aspect the present invention provides a hands-free method of cleaning a shower head 2. The method comprises the steps of providing a substantially hollow container member 4 having a substantially U-shaped member 14 disposed on an end of the container member 4. There is a step of attaching the substantially hollow container member 4 with said substantially U-shaped member 14 to a water line 12 having a shower head 2 disposed on an end of the water line 12. Next is a step of disposing the shower head 2 within the substantially hollow container member 4. Followed by a step of filling the substantially hollow container member 4 with a cleaning solution to a depth at least sufficient to cover an end of the shower head 2 and then soaking the shower head 2 for a predetermined time, such predetermined time being sufficient to clean the shower head 2 and remove any deposits built up one of thereon and therein.

Shower head flush is a practical product designed to provide consumers with a simple, hands-free way to clean shower heads. The apparatus comprises a clear acrylic box with an adjustable hook engageable with one end of he box for attachment to the shower head. The user simply fills the container with a predetermined amount of a desired cleaning solution and then hang the unit from the shower head. The order of operation could be reversed in that the unit could be hung from the shower head and then filled with the cleaning solution. Once the apparatus is in place the apparatus can remain on the shower head until removed after the shower head is cleaned.

The apparatus is made of a durable plastic, preferably an acrylic. The reusable apparatus measures approximately 3″ by 5″ which is sufficiently large enough to enclose a shower head.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for cleaning a shower head, said apparatus comprising:
(a) a substantially hollow container member having a predetermined shape and formed of a predetermined material for holding a cleaning solution, said substantially hollow container member having a bottom portion and a sidewall portion extending upwardly from said bottom portion, said sidewall portion enclosing an entire perimeter of said bottom portion;
(b) a hanging means disposed on a predetermined portion of said sidewall portion of said container member for hanging said substantially hollow container member from a shower water line so that an end of such shower head is enclosed in said container member holding such cleaning solution.

2. The apparatus, according to claim 1 wherein said hanging means includes a generally U-shaped member for attachment with a water line having a shower head disposed on an end of such water line wherein such end of such shower head is disposed within said substantially hollow container member.

3. The apparatus, according to claim 1, wherein said predetermined shape of said substantially hollow container member is one of oval, circular and rectangular.

4. The apparatus, according to claim 3, wherein said predetermined shape is substantially rectangular.

5. The apparatus, according to claim 3, wherein said substantially hollow container member is between about 2½ inches and about 3½ inches wide and between about 4½ inches and about 5½ inches long and between about 2½ inches and about 3½ inches high.

6. The apparatus, according to claim 1, wherein said predetermined material is selected from one of plastic and metal.

7. The apparatus, according to claim 6, wherein said predetermined material is plastic.

8. A hands-free method of cleaning a shower head, said method comprising the steps of:
(a) providing a substantially hollow container member having a substantially U-shaped member disposed on an end of said container member;
(b) attaching said substantially hollow container member with said substantially U-shaped member to a water line having a shower head disposed on an end of said water line;
(c) disposing said shower head within said substantially hollow container member;
(d) filling said substantially hollow container member with a cleaning solution to a depth at least sufficient to cover an end of said shower head; and
(d) soaking said shower head for a predetermined time, said predetermined time being sufficient to clean said shower head and remove any deposits built up one of thereon and therein.
